(19) United States
(12) Patent Application Publication
(10) Pub. No.: US 2024/0171433 A1
(43) Pub. Date: May 23, 2024

(54) ENHANCED FD PRECODING ON CSI-RS BY UE MULTIPLEXING

(71) Applicant: NOKIA SOLUTIONS AND NETWORKS OY, Espoo (FI)

(72) Inventors: Rana AHMED, Munich (DE); Salah Eddine HAJRI, Antony (FR); Filippo TOSATO, Bures sur Yvette (FR); Eugene VISOTSKY, Buffalo Grove, IL (US)

(21) Appl. No.: 18/271,936

(22) PCT Filed: Dec. 22, 2021
(86) PCT No.: PCT/EP2021/087226

§ 371 Date: Jul. 12, 2023

Related U.S. Application Data
(60) Provisional application No. 63/138,364, filed on Jan. 15, 2021.

(51) Int. Cl. H04L 27/26; H04B 7/06

(52) U.S. Cl. CPC H04L 27/2605; H04B 7/0626; H04L 27/261

(57) ABSTRACT

In an enhanced frequency domain precoding environment, a solution for transmitting channel state information reference signal to user equipments from the same channel state information reference signal port using the determined cyclic shifts, where user equipments are to share the same channel state information reference signal port.

### TECHNICAL FIELD

The examples and non-limiting embodiments relate generally to communications and, more particularly, to enhanced FD precoding on CSI by UE multiplexing.

### BACKGROUND

It is known for a network node to use channel state information obtained from a user equipment for scheduling in a communication network.

### BRIEF DESCRIPTION OF THE DRAWINGS

The foregoing aspects and other features are explained in the following description, taken in connection with the accompanying drawings, where:

FIG. 1 is a block diagram of one possible and non-limiting system in which the example embodiments may be practiced.

FIG. 2 is a flowchart of partial reciprocity based port selection CB in Rel17.

FIG. 3 shows an example of FD precoding for 1 UE.

FIG. 4 shows an example many to one mapping of an FDM scheme.

FIG. 5 shows an example split compression scheme between the gNB and UE.

FIG. 6 shows an example UE multiplexing in the delay domain by FD precoding and cyclic shift application.

FIG. 7 illustrates the effect of R on UE multiplexing.

FIG. 8A shows a configuration where two or more UEs can share the same CSI-RS port at the same delay positions, CIR as seen at the gNB side for 2 UEs.

FIG. 8B illustrates where the gNB sends two different CSI-RS ports (or SD-FD shifts) to the two UEs, each with a different FD precoding.

FIG. 8C shows where with the described UE specific/SD-FD shift specific CS, the gNB sends 1 CSI-RS port (or SD-FD shift) to the two UEs, with the same FD precoding.

FIG. 9 is an example apparatus configured to implement the examples described herein.

FIG. 10 shows an example method to implement the examples described herein.

FIG. 11 shows another method to implement the examples described herein.

### DETAILED DESCRIPTION OF EXAMPLE EMBODIMENTS

The following acronyms and abbreviations that may be found in the specification and/or the drawing figures are defined as follows:
2D two dimensional
3GPP third generation partnership project
4G fourth generation
5G fifth generation
5GC 5G core network
Alt alternative
AMF access and mobility management function
ASIC application-specific integrated circuit
BWP bandwidth part
CB codebook
CDM code division multiplexing
CIR channel impulse response
CQI channel quality indicator
CS cyclic shift
CSI channel state information
CSI-RS channel state information reference signal
CU central unit or centralized unit
DC downlink channel or dual connectivity
DCI downlink control information
DFT discrete fourier transform
DL downlink
DMRS demodulation reference signal
DSP digital signal processor
DU distributed unit
eNB evolved Node B (e.g., an LTE base station)
EN-DC E-UTRA-NR dual connectivity
en-gNB node providing NR user plane and control plane protocol terminations towards the UE, and acting as a secondary node in EN-DC
E-UTRA evolved universal terrestrial radio access, i.e., the LTE radio access technology
F1 control interface between CU and DU
FD frequency domain
FDD frequency division duplex
FDM frequency division multiplexing
FeMIMO further enhanced MIMO
FFS for further study
FPGA field-programmable gate array
FR1 frequency range 1
FR2 frequency range 2
gNB base station for 5G/NR, i.e., a node providing NR user plane and control plane protocol terminations towards the UE, and connected via the NG interface to the 5GC
GoB grid-of-beam
IE information element
I/F interface
I/O input/output
ini initial
JT joint transmission
LCC linear combination coefficients
LMC location management component
LMF location management function
LTE long term evolution (4G)
MAC medium access control
MAC-CE MAC control element
MIMO multiple input multiple output
MME mobility management entity
NCJT non-coherent joint transmission
ng or NG new generation
ng-eNB new generation eNB
NG-RAN new generation radio access network
NR new radio (5G)
N/W network
OFDM orthogonal frequency division multiplexing
PDCP packet data convergence protocol
PHY physical layer
PMI precoding matrix indicator
PRB physical resource block
PS port selection
R granularity parameter
RAN radio access network
RAN1 radio layer 1
RAN1# RAN1 meeting
RB resource block
Rel or Rel- or R# release/meeting
RLC radio link control
RRC radio resource control (protocol)
RRH remote radio head
RS reference signal
RU radio unit
Rx receiver or reception
SB subband
SD space/spatial domain
SDAP service data adaptation protocol
SGW serving gateway
shiftVec shift vector
SRS sounding reference signal(s)
SSB synchronization signal block
TRP transmission and reception point
Tx transmitter or transmission
UE user equipment (e.g., a wireless, typically mobile device)
UL uplink
UPF user plane function
X times
Xn Xn network interface

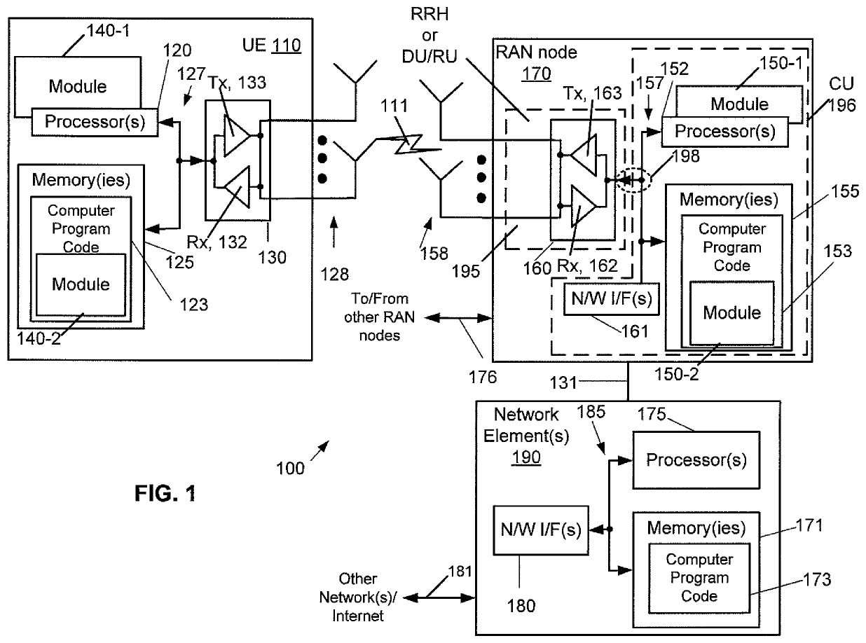

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111. The modules 140-1 and 140-2 may be configured to implement the functionality of the UE as described herein.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that controls the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell is supported by only one gNB-DU 195. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195. The modules 150-1 and 150-2 may be configured to implement the functionality of the base station described herein. Such functionality of the base station may include a location management function (LMF). Such LMF may also be implemented within the RAN node 170 as a location management component (LMC).

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

It is noted that description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations such as functionality of an LMF as described herein. In some examples, a single LMF could serve a large region covered by hundreds of base stations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

UE 110, RAN node 170, and/or network element(s) 190, (and associated memories, computer program code and modules) may be configured to implement the methods described herein, including a method to implement enhanced FD precoding on CSI by UE multiplexing. Thus, computer program code 123, module 140-1, module 140-2, and other elements/features shown in FIG. 1 of UE 110 may implement user equipment related aspects of the methods described herein. Similarly, computer program code 153, module 150-1, module 150-2, and other elements/features shown in FIG. 1 of RAN node 170 may implement gNB/TRP related aspects of the methods as described herein. Computer program code 173 and other elements/features shown in FIG. 1 of network element(s) 190 may be configured to implement network element related aspects of the methods as described herein.

Having thus introduced a suitable but non-limiting technical context for the practice of the example embodiments, the example embodiments are now described with greater specificity.

The gNB uses a downlink reference signal (CSI-RS, SSB, etc.) transmission and Type I or Type II codebook feedback from the UE in order to obtain channel state information (CSI) at the gNB side needed for DL precoding, scheduling etc. After the enhancement of Rel 16 on precoding, Rel 17 enhancement related to partial reciprocity such that the gNB knows, based on UL SRS, the delay profile of the channel (FD precoding can be done). This avoids the need for UE to feedback W_{f} component to the gNB.

In the discussion of FD precoding for CSI enhancement in Rel17 for FDD, one main issue is the large CSI-RS overhead required, due to the fact that the CSI-RS transmission has to be UE specific, since the SD and the FD precoding weights are derived depending on the UE channel characteristics. Also, the number of CSI-RS ports needed increase linearly with the number of tap delays considered for FD precoded. One CSI-RS port per SD-FD pair. With many FD components (delay taps), there is need for many CSI-RS ports even for one SD component.

Therefore, there is a need for solutions to reduce the CSI-RS overhead

Described herein is a new method to reduce the CSI-RS overhead in DL, where the precoded pilots of two or more UEs can be multiplexed together on the same time frequency resource elements and can be separated by applying a cyclic shift at the gNB and compensating for it at the UE side respectively. Hence, a CSI-RS port moves from being UE specific in the original proposal of Rel17 into being shared among a group of UEs.

Based on the method described herein, gNB processing may include determining that at least two UEs are to share the same CSI-RS port; determining cyclic shifts to be used for each of the at least two UE, wherein the cyclic shift for at least one of the UEs is smaller than the delay spread of the channel; and transmitting CSI-RS to the at least two UEs from the same CSI-RS port by using the determined cyclic shifts. At the UE side, the UE receives cyclic shift(s) to be used for this and this CSI-RS port.

In frequency division duplex (FDD) 5G systems, the gNB uses downlink reference signal (CSI-RS, SSB, etc.) transmission and Type I or Type II codebook feedback from the UE in order to obtain channel state information (CSI) at gNB side needed for DL precoding, scheduling etc.

In 5G NR, advanced CSI codebooks were specified to accommodate both single and multi-user MIMO operations. Rel-15 specified Type I and Type II codebooks, the latter of which provides considerable precoding matrix indicator (PMI) accuracy. CSI enhancements continued in Rel-16 where the reduction of Type II overhead was the focus in order to alleviate the strain on uplink resources. This was achieved through frequency domain compression using discrete Fourier Transform (DFT) basis subsets. Rel-16 Type II codebook proved to be quite the advance in CSI feedback. Nevertheless, 3GPP identified that further improvements can be achieved by exploiting partial uplink and downlink channel reciprocity.

In Rel-17, work on CSI enhancements for NR continues. In the description of the work item “Further enhancements on MIMO for NR”, one may read,
“4. Enhancement on CSI measurement and reporting:
a. Evaluate and, if needed, specify CSI reporting for DL multi-TRP and/or multi-panel transmission to enable more dynamic channel/interference hypotheses for NCJT, targeting both FR1 and FR2.
b. Evaluate and, if needed, specify Type II port selection codebook enhancement (based on Rel.15/16 Type II port selection) where information related to angle(s) and delay(s) are estimated at the gNB based on SRS by utilizing DL/UL reciprocity of angle and delay, and the remaining DL CSI is reported by the UE, mainly targeting FDD FR1 to achieve better trade-off among UE complexity, performance and reporting overhead.”

The incorporation of partial reciprocity operations in 5G NR CSI framework is to be based on type II port selection codebook enhancements, as indicated in the WI description. Type II port selection codebook is based on spatially beamformed CSI-RS.

### Type II CB

In Rel. 15 type II codebook, the precoding matrix, per layer, is written as

W=W₁W₂ Equation (1)

The final precoder at the gNB is a weighted linear combination of L orthogonal beams per polarization as

\tilde{w}_{r,l}=Σᵢ₌₀^{L-1}bₖ_{₁}_{⁽ⁱ⁾}ₖ_{₂}_{⁽ⁱ⁾}·p_{r,l,i}^{(WB)}p_{r,l,i}^{(SB)}·c_{r,l,i} Equation (2)

The term bₖ_{₁}_{⁽ⁱ⁾}ₖ_{₂}_{⁽ⁱ⁾} is the long-term two-dimensional (2D) discrete Fourier transform (DFT) beam, the term p_{r,l,i}^{(WB)} is the beam power scaling factor for wideband, the term p_{r,l,i}^{(SB)} is the beam power scaling factor for subband, and the term c_{r,l,i} is the beam combining coefficient.

Where the grid-of-beam matrix W₁ is of size 2N₁N₂×2L and is built out of L orthogonal vectors/beams per polarization r from a set of oversampled O₁O₂N₁N₂ DFT beams, where N₁ and N₂ are the number of antenna ports in horizontal and vertical domains. O₁ and O₂ are the oversampling factors in both dimensions. This collection of vectors can be used to approximate the eigenvectors of the channel covariance matrix by means of suitable weighted linear combinations. This operation achieves a compression in the spatial domain (SD), hence the resulting 2L beams are also referred to as SD components.

Linear combination subband matrix W₂ of size 2L×N₃, where N₃ is the number of frequency subbands, which is used for the weighed linear combination of the columns of W₁ yielding the aforementioned approximation of the l strongest eigenvectors of the channel covariance matrix.

Enhancement of Type II CSI feedback for Rel. 16 was agreed in 3GPP based on exploiting the frequency correlation inside W₂. A frequency domain compression scheme is applied on subband matrix W₂. The precoder for each layer and across frequency-domain units W is derived as follows

W=W₁\tilde{W}₂W_{f}^{H} Equation (3)

\tilde{W}₂ is a 2L×M matrix of linear combining coefficients, W_{f} is an N₃×M FD compression matrix (analogous to W₁ in frequency domain), and where M is the number of frequency domain (FD) components.

In Rel.16 type II CSI, the UE feeds back to the gNB: 1) Grid-of-beam matrix W₁, 2) FD basis subset W_{f}, and 3) linear combination coefficients (LCC) \tilde{W}₂

At the UE side, \tilde{W}₂ can be computed as

\tilde{W}₂=W₂W_{f} Equation (4)

as explicitly indicated in Rel. 17 NR MIMO work item description. Type II port selection enhancements are to take into consideration uplink and downlink channel partial reciprocity in terms of both delay(s) and angle(s). In this framework, a new CSI scheme was proposed by the Applicant/assignee of this disclosure.

A CSI scheme has been proposed in which the partial reciprocity of the delay information was exploited to reduce the complexity at the UE side. This scheme assumed existing knowledge of the delay information on DL (W_{f}) at the gNB side and is comprised of three main steps which are listed here: 1) At the gNB side, the CSI-RS ports are pre-coded with W_{f}, by windowing (Hadamard product) the CSI-RS pilots with phase ramps corresponding to each significant delay tap on the DL, i.e. with the columns in W_{f}. 2) At the UE side, it can be shown that the inner product of received signal on the different frequency subbands with the known pilot sequence (CSI-RS) yields nothing but the compressed channel coefficients \tilde{H}_{2L×M×N}_{ᵣ}. After a step of eigenvector computation on \tilde{H}_{2L×M×N}_{ᵣ}, UE gets \tilde{W}₂ which is then fed back to gNB. Hence the UE is spared from the effort of computing the W_{f} as required in Rel.16. 3) At gNB side, given knowledge of spatial and frequency domain precoders and given the UE PMI feedback, the gNB is capable of building the whole CSI used for design of the DL precoder.

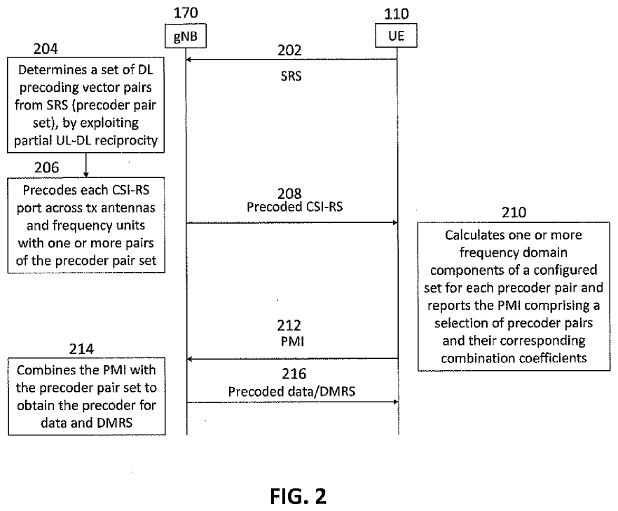

FIG. 2 depicts the signaling operation between the UE and gNB with the three steps mentioned above.

In particular, as shown in FIG. 2, at 202 the UE 110 transmits SRS to the gNB 170. At 204, the gNB 170 determines a set of DL precoding vector pairs from the SRS (precoder pair set), by exploiting partial UL-DL reciprocity. At 206, the gNB 170 precodes each CSI-RS port across Tx antennas and frequency units with one or more pairs of the precoder pair set. At 208, the gNB 170 transmits the precoded CSI-RS to the UE 110.

At 210, the UE calculates one or more frequency domain components of a configured set for each precoder pair and reports the PMI comprising a selection of precoder pairs and their corresponding combination coefficients. At 212, the UE transmits the PMI to the gNB 170. At 214, the gNB 170 combines the PMI with the precoder pair set to obtain the precoder for data and DMRS. At 216, the gNB 170 transmits the precoded data/DMRS to UE 110.

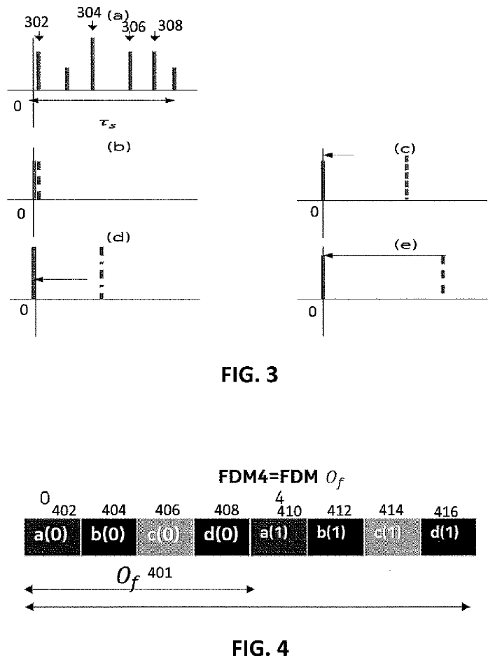

FIG. 3(a to e) depicts an illustration of the physical interpretation of step 1 mentioned above. Assuming a UE with a 6 tap channel, whose delay profile is known at gNB from UL SRS measurements as shown in FIG. 3a. The gNB can choose the strongest 4 delay taps (marked with arrows 302, 304, 306, and 308). For every delay tap value d, the gNB applies an exponential phase ramp, which corresponds to the delay value, to the transmitted pilots by a Hadamard product (element by element multiplication): Sₚ(d)=F(d)·Sₚ, where F(d) is a 1D vector containing the exponential phase ramp coefficients.

The physical interpretation of that step is that the whole CIR is shifted to the left by a value of d samples, hence the delay tap which was originally at position d is shifted to position 0 as shown in FIG. 3b-e for the 4 selected taps. The dashed taps in FIG. 3b-e indicate the original position of the tap, and the solid taps indicate the final position after shifting. Note that in FIG. 3b-e, only the shifting operation is depicted for the selected tap, the rest of the taps are not shown. In other words, the rest of the taps would still exist only in different positions than zero position, even though they are not shown in the FIG. 3.

Once the tap has been shifted to DC position, a simple summation is sufficient to obtain the complex value of the channel tap coefficient from the FD precoded pilots. The same scheme was discussed in RAN1#102e and RAN1#103e, where the following agreement was made:

### Agreement

Taking Type II port selection codebook enhancement (based on Rel.15/16 Type II port selection) as a starting point, study following aspects, taking into account trade-off among UE complexity, performance and reporting/RS overhead:

Enhancement on codebook structure, e.g.,: (Alt 1) Enhancement based on R16 Type II PS CB type structure, enhancements on W₁ quantization, e.g., with enhanced port selection in W₁, with modified value range of L taking into account beamforming mechanism for CSI-RS, and with layer-specific port selection. Enhancements on W_{f} quantization, e.g., with a smaller value of Mᵥ, with a modified value range of R, with multiple values of Mᵥ for different SD basis, with enhanced FD basis selection in W_{f}. Restrictions/Relaxation, e.g. for the size of the PMI indicators for SD basis, FD basis and bitmap. How UE distinguishes SD basis and FD basis or in a pre-defined set. Enhancement on W2 quantization: coefficients for selected ports

(Alt 2) Enhancement based on R15 Type II PS CB type structure. Enhancement on W₁ quantization, e.g.,: enhanced port selection, X out of P SD-FD pairs are selected. X≤P (if polarization independent) or P/2 (if polarization common) whereas P≤P_{CSI-RS} only or P can be larger than P_{CSI-RS}. How to map P SD-FD pairs into P_{CSIRS} CSI-RS ports and inform to UE. Enhancement on W₂ quantization: coefficients for the selected X pairs

### Agreement (cont'd)

Enhancements on indication/reporting mechanism, e.g.: Separate triggering for reporting of W₁ and W_{f} (for Alt 1) or reporting of W₁ and the rest of the PMI components (for Alt 2). Report only a subset of PMI components. Enhancement on SD/FD basis indication, selection and reporting mechanism. UE reporting to support gNB calibration including UL/DL time difference. CQI enhancements, e.g., CQI reporting mechanism considering FDD reciprocity. Etc.

Enhancements on RS triggering/signaling/transmission mechanism, e.g. for SRS and/or CSI-RS, CSI-RS utilization conveying one or more SD-FD pairs per port, timing restrictions between SRS and CSI-RS transmission, etc. Other enhancement are not excluded.

In RAN1#103e, it was agreed that Rel17 is to support enhancements utilizing UL/DL reciprocity where 5 alternatives were defined for study:

```
Agreement
Port selection codebook enhancements utilizing DL/UL reciprocity of angle and/or delay is supported in
Rel-17.
Agreement
Study following alternatives, and select one or a combination of multiple alternatives for Rel-17 in
RAN1#104-e:
  Alt0: Based on W = W₁W₂ or W = W₁W₂W_{f}, W₁ can be an identity matrix
  Alt1 and Alt2: Based on W = W₁W₂, study following detailed design of matrices W₁, at least for rank 1.
    • Altl: W₁ ∈ [symbol]   ^{P}^{_{CSI-RS}} ^{×K}^{₁}(K₁ ≤ P_{CSI-RS}) is a port selection matrix in order to freely select K₁ ports
        $out of {P}_{CSI - RS} CSI - RS ports or \frac{{K}_{1}}{2} ports out of \frac{{P}_{CSI - RS}}{2} CSI - RS ports ( FFS polarization -$
      common/specific selection) whereas each column of W₁ has only one element of “1”
    • Alt2: W₁ ∈ [symbol]   ^{P}^{_{SD-FD}} ^{×K}^{₂}(K₂ ≤ P_{SD-FD} = O_{f}P_{CSI-RS,}, O_{f} ≥ 1) is a SD-FD basis selection matrix in
        $order to freely select {K}_{2} bases out of {P}_{SD - FD} bases or \frac{{K}_{2}}{2} bases out of \frac{{P}_{SD - FD}}{2} bases ( FFS$
        polarization-common/specific selection) whereas each column of W₁ has only one element of “1”
          ○ FFS the mechanism of conveying SD-FD beamforming bases using CSI-RS ports
Agreement
Alt3, Alt4, and Alt5: Based on W = W₁W₂W_{f}^{H}, study following detailed design of matrices W₁ and
W_{f} , at least for rank 1.
    •  Alt3: W₁ ∈ [symbol]   ^{P}^{_{CSI-RS}} ^{×K}^{₁} (K₁ ≤ P_{CSI-RS}) is a port selection matrix in order to freely select K₁ ports
        $out of {P}_{CSI - RS} CSI - RS ports or \frac{{K}_{1}}{2} ports out of \frac{{P}_{CSI - RS}}{2} CSI - RS ports ( FFS polarization -$
        common/specific selection) whereas each column of W₁ has only one element of “1”
          ○ Alt3-0 (one SD-FD/SD pair per port):W_{f} ∈ C^{N}^{₃}^{×M}^{ᵥ} ( Mᵥ ≤ N₃) is a DFT based compression
              matrix (FFS: configured/indicated to the UE and/or selected/reported by the UE), whereas N₃ =
              N_{CQISubband}*R and Mᵥ ≥ 1.
          ○ Alt3-1 (Multi-SD-FD pairs per port):W_{f} ∈ C^{N}^{₃}^{×} ^{M}^{ᵥ} ( Mᵥ ≤ N,N ≤ N₃) is a DFT matrix
              selected by the UE from N pre-configured/pre-defined DFT vectors, whereas N₃ =
              N_{CQISubband}*R and Mᵥ ≥ 1.
                ▪ FFS the mechanism of conveying SD-FD beamforming bases using CSI-RS ports
                ▪ Note that Mᵥ = N is not excluded by gNB/codebook configuration.
          ○ Alt3-2 (Multi-SD-FD/SD pairs per port): W_{f} ∈ [symbol] ^{K}^{₃}^{×M} (M ≤ K₃) is a selection matrix in
              order to select M SD-FD basis whereas each column of W_{f} has only one element of “1”,
                ▪ FFS the mechanism of conveying SD-FD beamforming bases using CSI-RS ports
                ▪ Note that W_{f} can be an identity matrix
Agreement
    • Alt4: W₁ ∈ [symbol]  ^{P}^{_{group}} ^{×K}^{₄} (K₄ ≤ P_{group} ) is a port-group selection matrix to freely select K₄ groups
        out of P_{group} port groups or K₄/2 groups out of P_{group} /2 port groups (FFS polarization-
        common/specific selection) whereas P_{CSI-RS} CSI-RS ports in a resource are divided into P_{group}
        groups with K₅ ports per group, and each port group corresponding to the same SD basis
          ○ W_{f} ∈ [symbol] ^{K}^{₅}^{×M}(M ≤ K₅) is a selection matrix to select the same M ports across all port groups
              each column of W_{f} has only one element of “1”.
    • Alt5: W₁ ∈ [symbol]  ^{P}^{_{SD-FD}} ^{×K}^{₂}(K₂ ≤ P_{SD-FD} = O_{f}P_{CSI-RS,}, O_{f} ≥ 1) is a SD-FD basis selection matrix in
        $out of {P}_{CSI - RS} \text{CSI-RS} ports or \frac{{K}_{2}}{2} ports out of \frac{{P}_{CSI - RS}}{2} \text{CSI-RS} ports ( FFS \text{polarization-}$
        polarization-common/specific selection) whereas each column of W₁ has only one element of “1”
          ○  W_{f} ∈ C^{N}^{₃} ^{×M}^{ᵥ}( Mᵥ ≤ N, N ≤ N₃) is a DFT based compression matrix (FFS:
              configured/indicated to the UE and/or selected/reported by the UE), whereas N₃ =
              N_{CQISubbend}*R and Mᵥ ≥ 1.
          ○ FFS the mechanism of conveying SD-FD beamforming bases using CSI-RS ports
```

In the discussion of FD precoding for CSI enhancement in Rel17 for FDD, one main issue is the large CSI-RS overhead required, due to the fact that the CSI-RS transmission has to be UE specific, since the SD and the FD precoding weights are derived depending on the UE channel characteristics. In addition, as shown in FIG. 3, the number of CSI-RS ports needed increase linearly with the number of tap delays considered for FD precoded (in that case 4×). Therefore, there is a need for solutions to reduce the CSI-RS overhead.

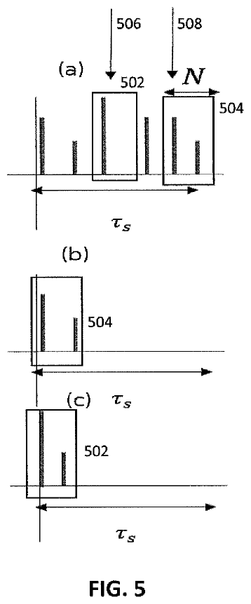

In order to deal with this issue, several proposals have been made in Alt 1-5 listed in section 2, for example (numbers 1-3 immediately below):
1) Mapping several SD-FD bases to one CSI-RS ports using FDM (R1-2009529) or CDM (e.g. Alt2, Alt 3). The idea here is to multiplex O_{f} 401 SD-FD bases in frequency domain (on different PRBs) on 1 CSI RS Port as shown in FIG. 4 for the FDM case, which shows 1 CQI subband consisting of 8 PRBs, the PRBs being a(0) 402, b(0) 404, c(0) 406, d(0) 408, a(1) 410, b(1) 412, c(1) 414, and d(1) 416. Each letter within FIG. 4 corresponds to a different SD-FD base.

One drawback of this scheme is that UE complexity no longer scales with the number of ports per CSI-RS resource, but rather depends on the total number of SD-FD bases. Besides, certain UE's implementations may not be suitable for processing multiple precoding bases per port, which may require an ad-hoc redesign of the channel estimation block.
2) A split compression scheme, where several FD taps are estimated by UE per window (is to be studied in Alt 3-0, 3-1, 5). This approach trades-off CSI-RS overhead for some additional UE complexity and feedback overhead, as a UE is configured to calculate some additional FD components that would otherwise be applied to CSI-RS ports by the gNB.
3) Reducing the density of a CSI-RS resource by configuring a resource every other RB (density 0.5, already available), or every one in 4 RBs (density 0.25). However, this solution also requires some other changes in the current standard specifications, for example to the startingRB, which determines the frequency occupation of a CSI-RS resource, and currently can only be configured as integer multiples of 4 RBs. Another drawback of this approach is that the frequency occupation of a CSI-RS resource is configured in RRC signalling, hence it is not possible to adapt density and frequency allocation of CSI-RS resources dynamically with the traffic/scheduling needs of the network.

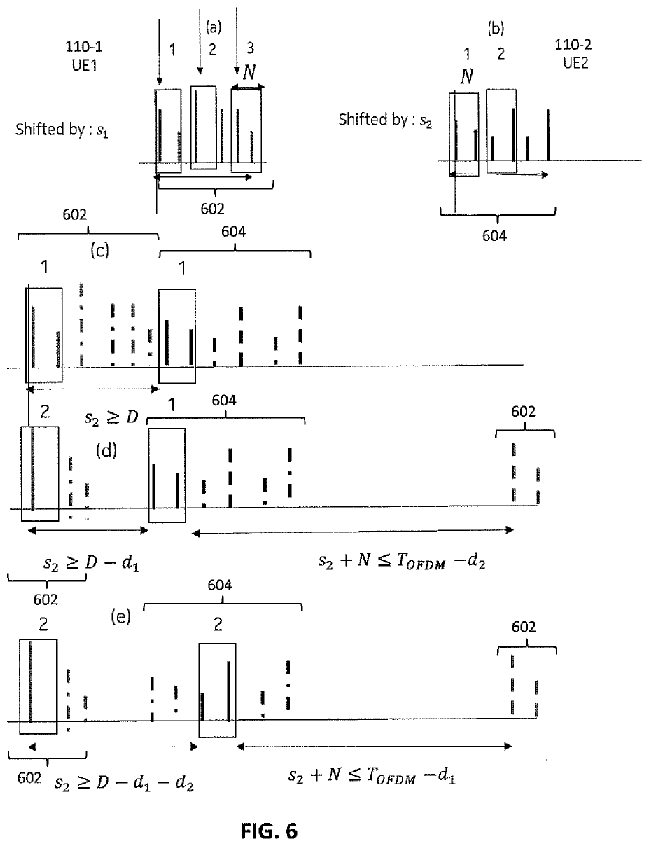

As proposed in R1-2008909, a split compression scheme is described, in which the CIR of a UE is divided into several ‘chunks’ or ‘windows’ as shown in FIG. 5 (refer e.g. to windows 502 and 504). Two windows in this case are placed in the area of dominant components, each window has N samples within. The gNB is going to apply FD precoding shifts corresponding to the starting window positions in each window (marked with arrows 506 and 508). As a result, the UE receives two CSI-RS ports, each one FD precoded with the starting window positions in each window (marked with arrows 506 and 508). Instead of doing a summation, the UE would have to do a DFT operation within each window and select the strongest Mᵥ≤N components, where the values of Mᵥ and N are configured by the gNB.

The scheme in FIG. 4 can be seen as a generalization of the scheme in FIG. 3, where in the case of FIG. 3 N=1 and Mᵥ=1. The advantages of the scheme in FIG. 3 are: 1) Reduced CSI-RS overhead (in this example two CSI-RS ports are needed instead of four); and 2) the potential to achieve higher accuracy because it allows the UE to pick the strongest delay positions within a window, hence can be more resistant against partial reciprocity errors since the UL and DL channels are not identical in FDD.

In return, the scheme in FIG. 4 requires higher UE complexity where the UE now needs to do DFT operation instead of summation, and depending on the channel delay profile there is a risk of non-optimal placement of the windows at gNB.

In UL sounding reference signal (SRS) transmission, in order to reduce the amount of resources used in UL, the different UEs can apply different cyclic shifts in order to shift the CIR of each user to a specific position in the delay domain as described in 3GPP 38.211 section 6.3.2.

Accordingly, described herein is a new method to reduce the CSI-RS overhead in DL, where the precoded pilots of two or more UEs can be multiplexed together on the same time frequency resource elements and can be separated by applying a cyclic shift at gNB and compensating for it at UE side respectively. The new method can be applied on the two previously mentioned approaches to reduce DL CSI-RS overhead: SD-FD shift to port mapping and split compression.

Different from each UE applying a UE/port specific cyclic shift as in SRS, in the examples described herein the gNB applies in DL a UE/port specific shift on the UE specific CSI-RS pilots in the same step as the FD precoding step for Release 17 UEs. Hence, a CSI-RS port moves from being UE specific as in the original proposal of Rel17 into being shared among a group of UEs.

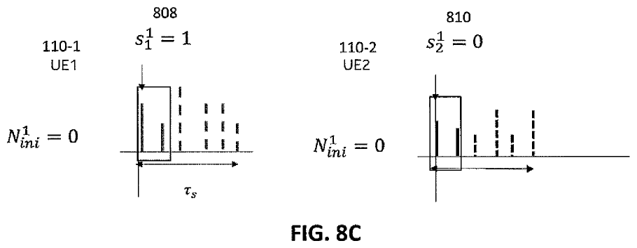

In some configurations (e.g. as in FIG. 8—refer to FIG. 8A, FIG. 8B, and FIG. 8C) the shift does not separate the CIR of both users but rather is used to align both windows in the delay domain to maximize the channel energy captured by each user. This is a different mode of operation compared to the cyclic shift applied in SRS transmission by different UEs.

Furthermore, the optimum cyclic shift depends not only on the maximum channel delay (as in case of SRS transmission), but also on the delay values used in the FD precoding of all multiplexed UEs. Hence, there is a strong case to allow such cyclic shifts to vary dynamically. Since the change in user channel characteristics implies the gNB is to apply different FD precoding shifts to the different UEs, it is an advantage if the gNB can dynamically adjust the cyclic shift per CSI RS port e.g. in MAC-CE.

In general, the examples described herein can be used also without FD precoding. However, there is high motivation to consider it for Rel17 UEs where FD precoding implies that the UEs need to do the wideband processing of the CSI-RS pilots anyway.

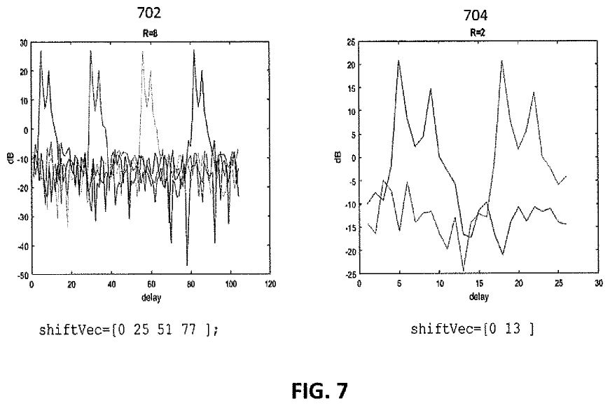

FIG. 6 depicts an illustration of the idea described herein by an example of 2 UEs: UE 1 110-1 and UE 2 110-2, each assuming different SD precoding filters. The CIR of UEs 1 and 2 are depicted in 5a and 5b respectively. For each UE the FD precoding weights are going to be derived depending on the UE channel characteristics. On top of the FD precoding, a cyclic shift (sᵢ) is going to be applied to the CSI-RS pilots of each UE, so that the effective CIR of UE #i is shifted to the right by the value of sᵢ,

Sₚⁱ(dᵢ)=F(−sᵢ)·F(dᵢ)·Sₚ

where dᵢ is the delay applied inside FD precoding step for UE#i.

As shown in FIG. 6, UE1 110-1 is not shifted i.e. s₁=0 and UE2 110-2 is shifted by s₂>0. In order to avoid ISI, the value that s₂ takes should take into consideration: 1) the maximum delay that a CIR can take (assume it can be called D); 2) the frequency granularity of the CSI-RS pilots (controlled by parameter R in Rel17); and 3) the values of the delays applied inside FD precoding for the different UEs i.e. d₁ and d₂ in the example below.

FIGS. 6c to e depict several configurations where CSI-RS of UE1 110-1 and UE2 110-2 are multiplexed together in the delay domain.

Since different delays are applied on different CSI-RS ports, it can be beneficial to assign different cyclic shifts to different CSI-RS ports (or different SD-FD shifts).

Note that the second channel (corresponding to 604, the first channel being 602) can also belong to the same user where for example it corresponds to a different SD beam of the same user channel. However, the main advantage of multiplexing precoding vectors of different UEs in the same port is to maintain the rule of one precoding pair per port per UE, but at the same time being able to reuse the same UE-specific CSI-RS resource for multiple UEs.

The parameter R (field: numberOfPMI-SubbandsPerCQI-Subband-r16), determines how many PMI subbands are configured in relation to the number of CQI subbands: N₃=R×n_{SB}^{BWP}. In release 17, the value of N₃ determines the frequency unit to which CSI-RS precoding is applied, i.e., to how many consecutive PRBs the same FD precoding weight is applied. The higher the value of R, the higher the frequency granularity of the CSI-RS pilots and consequently the PMI.

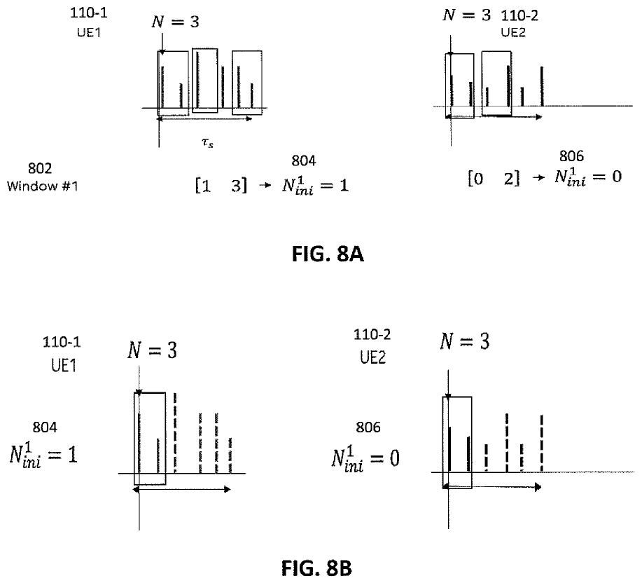

It is to be noted that R controls the number of RBs in a frequency unit (i.e., PMI subband): N_{PRB}^{SB}/R, where N_{PRB}^{SB} is the number of RBs in a CQI subband. Because the period in the transformed delay domain, T_{D}, illustrated in FIG. 6, is inversely proportional to the frequency unit, the larger the value of R the larger the period T_{D}, which makes it easier to multiplex users with cyclic delays as illustrated in FIG. 7.

In order to understand how the frequency granularity (controlled by R parameter) affects the UE multiplexing capability, refer to FIG. 7. The graph 702 shows where R=8, and the graph 704 shows where R=2. As shown in FIG. 7, the higher the value of R the smaller is the relative delay to the overall frequency resolution, i.e. more users can be multiplexed in the delay domain. In Release 16, R could take values of 1 or 2, in release 17 higher values of R [R1-2007592, R1-2007769] are expected.

In another configuration, in case both UEs are found to use the same SD precoder (for example if the SD precoder is derived from a GoB precoder. Note that this case can occur more specifically if the design on the GoB is common to a group of UEs). The gNB can choose to assign the different cyclic shifts to both UEs to have the best common window placement such that the maximum amount of energy is collected for all UEs. Note that sᵢ^{w} refers to the cyclic shift applied for user i and window #w.

For example, window#1 802 is found to be optimally placed at positions Nᵢₙᵢ¹=1 and Nᵢₙᵢ¹=0 for UE1 110-1 and UE2 110-2 respectively (refer to items 804 and 806). According to the baseline scheme in FIG. 8B, the gNB 170 could send two CSI-RS ports (or SD-FD shifts) one for each UE. For UE1 110-1, the gNB 170 would shift the whole CIR to the left by 1 sample and for UE2 110-2 no shift is needed, i.e. FD precoding weight vector happens to be a vector of 1s.

In the method described herein, as shown in FIG. 8C, the gNB 170 may choose to use different cyclic shifts for both UEs (can also be port specific) such that both UEs read exactly the same CSI-RS resource time-frequency elements for that port and by undoing the UE specific cyclic shifts where the window positions are optimally placed depending on the UE individual channels. In FIG. 8C, a common window position is taken as Nᵢₙᵢ=0, in order not to compromise the performance of UE1 110-1 the gNB 170 assigns UE1 s₁¹=1 808 so the UE1 110-1 itself knows it should compute the DFT coefficients from position 1 to position N+1. UE2 110-2 is assigned s₂¹=0 810.

The cyclic shifts can be actually fixed in RRC configuration, however from examples in FIG. 6(a to e) and FIG. 8 (including FIG. 8A, FIG. 8B, and FIG. 8C, it is possible to see the motivation for making the cyclic shifts dynamic and SD-FD shift specific.

Currently in Release 17, as shown in FIG. 4, a mapping procedure is defined where several SD-FD shifts can be mapped to one CSI-RS port (R1-2009529) where the frequency granularity parameter R is reduced in return for multiplexing in more SD-FD components per CSI-RS port. The examples described herein can also work in combination with this scheme, i.e. per SD-FD component independent of whether there is a one to one mapping between SD-FD components and CSI-RS ports or there is a many to one mapping between SD-FD components and CSI-RS ports.

The examples described herein may be summarized as follows (1-3): 1) gNB determines the required cyclic shifts per UE (per CSI-RS port/SD-FD shift if allowed) and applies the cyclic shifts to the different FD precoded pilots; 2) UE processes the received OFDM symbol, drops the cyclic prefix and compensates the effect of the cyclic shift (potentially per CSI-RS port/SD-FD shift); 3) UE then uses the processed pilots into the Release 17 chain.

An impact on the specification may come from the fact that the cyclic shifts need to be communicated from the gNB to the UE such that the UE can do the correct processing of the CSI-RS before starting the Release 17 processing.

For Alt 1, the cyclic shift is RRC configured in the codebook parameters for the different users, for example in a new IE CodebookConfig-r17, where a new field is placed containing the assigned cyclic shift per window or per UE (the window can be one SD-FD shift or CSI-RS port).

For Alt 2, the cyclic shift value can be explicitly and dynamically indicated by the gNB, via MAC-CE or DCI.

For Alt 3, the cyclic shift value can be implicitly and dynamically indicated by configuring a window of FD components for a UE to calculate. In this case the window configuration includes an initial value, besides its length, which corresponds to the cyclic delay of the shift applied to the precoding vectors of that UE.

The examples herein further relate to FeMIMO CSI enhancements on FR1 FDD reciprocity, as well as modifications to the enhanced Type II port selection codebook for FDD reciprocity operations and technical specifications for MIMO.

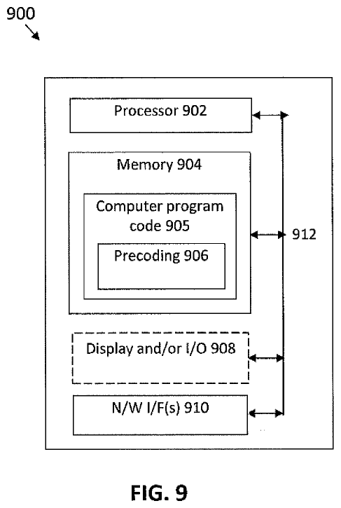

FIG. 9 is an example apparatus 900, which may be implemented in hardware, configured to implement the examples described herein. The apparatus 900 comprises a processor 902, at least one non-transitory memory 904 including computer program code 905, where the at least one memory 904 and the computer program code 905 are configured to, with the at least one processor 902, cause the apparatus to implement circuitry, a process, component, module, or function (collectively precoding 906) to implement the examples described herein based on enhanced FD precoding on CSI by UE multiplexing. The apparatus 900 optionally includes a display and/or I/O interface 908 that may be used to display aspects or a status of the methods described herein (e.g., as one of the methods is being performed or at a subsequent time). The apparatus 900 includes one or more network (N/W) interfaces (I/F(s)) 910. The N/W I/F(s) 910 may be wired and/or wireless and communicate over the Internet/other network(s) via any communication technique. The N/W I/F(s) 910 may comprise one or more transmitters and one or more receivers. The N/W I/F(s) 910 may comprise standard well-known components such as an amplifier, filter, frequency-converter, (de)modulator, and encoder/decoder circuitries and one or more antennas.

The apparatus 900 may be UE 110, RAN node 170 (e.g. gNB), or network element(s) 190 Thus, processor 902 may correspond respectively to processor(s) 120, processor(s) 152, or processor(s) 175, memory 904 may correspond respectively to memory(ies) 125, memory(ies) 155, or memory(ies) 171, computer program code 905 may correspond respectively to computer program code 123, module 140-1, module 140-2, computer program code 153, module 150-1, module 150-2, or computer program code 173, and N/W I/F(s) 910 may correspond respectively to N/W I/F(s) 161 or N/W I/F(s) 180. Alternatively, apparatus 900 may not correspond to either of UE 110, RAN node 170, or network element(s) 190.

Interface 912 enables data communication between the various items of apparatus 900, as shown in FIG. 9. Interface 912 may be one or more buses, or interface 912 may be one or more software interfaces configured to pass data between the items of apparatus 900. For example, the interface 912 may be one or more buses such as address, data, or control buses, and may include any interconnection mechanism, such as a series of lines on a motherboard or integrated circuit, fiber optics or other optical communication equipment, and the like. The apparatus 900 need not comprise each of the features mentioned, or may comprise other features as well.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

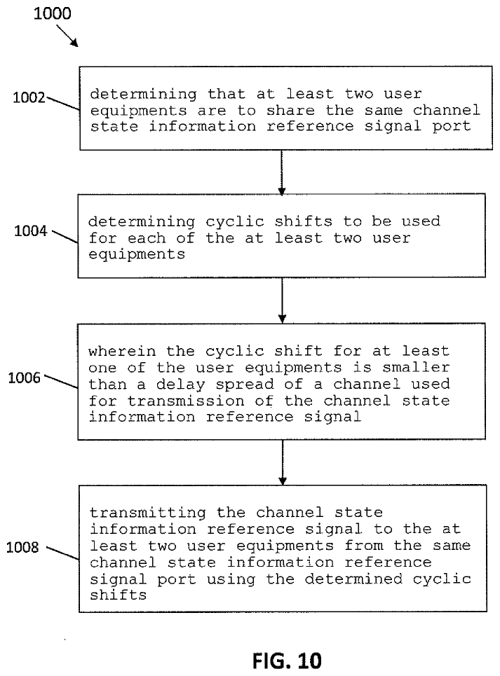

FIG. 10 is an example method 1000 to implement enhanced FD precoding on CSI by UE multiplexing, based on the example embodiments described herein. At 1002, the method includes determining that at least two user equipments are to share the same channel state information reference signal port. At 1004, the method includes determining cyclic shifts to be used for each of the at least two user equipments. At 1006, the method includes wherein the cyclic shift for at least one of the user equipments is smaller than a delay spread of a channel used for transmission of the channel state information reference signal. At 1008, the method includes transmitting the channel state information reference signal to the at least two user equipments from the same channel state information reference signal port using the determined cyclic shifts. Method 1000 may be implemented by a radio node such as gNB 170.

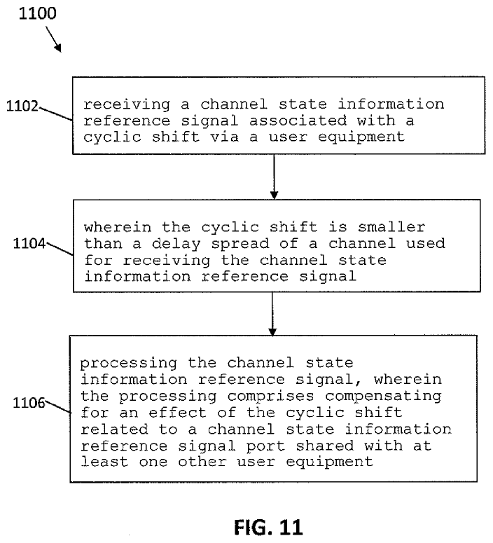

FIG. 11 is another example method 1100 to implement enhanced FD precoding on CSI by UE multiplexing, based on the example embodiments described herein. At 1102, the method includes receiving a channel state information reference signal associated with a cyclic shift via a user equipment. At 1104, the method includes wherein the cyclic shift is smaller than a delay spread of a channel used for receiving the channel state information reference signal. At 1106, the method includes processing the channel state information reference signal, wherein the processing comprises compensating for an effect of the cyclic shift related to a channel state information reference signal port shared with at least one other user equipment. Method 1100 may be implemented by a mobile terminal such as UE 110.

An example method includes determining that at least two user equipments are to share the same channel state information reference signal port; determining cyclic shifts to be used for each of the at least two user equipments; wherein the cyclic shift for at least one of the user equipments is smaller than a delay spread of a channel used for transmission of the channel state information reference signal; and transmitting the channel state information reference signal to the at least two user equipments from the same channel state information reference signal port using the determined cyclic shifts.

Other aspects of the method may include the following. The cyclic shift may be determined based on a delay value used in a frequency domain precoding pilot of the at least two user equipments. The cyclic shift may be configured to separate a frequency resource element shared on the channel state information reference signal port shared with the at least two user equipments. The cyclic shift may be configured to align at least one window in a delay domain. The cyclic shift may be a space domain and frequency domain shift.

An example method includes receiving a channel state information reference signal associated with a cyclic shift via a user equipment; wherein the cyclic shift is smaller than a delay spread of a channel used for receiving the channel state information reference signal; and processing the channel state information reference signal, wherein the processing comprises compensating for an effect of the cyclic shift related to a channel state information reference signal port shared with at least one other user equipment.

Other aspects of the method may include the following. The receiving may comprise receiving the channel state information reference signal as an orthogonal frequency division multiplexing symbol. Compensating for the effect of the cyclic shift may comprise separating a frequency resource element shared on the channel state information reference signal port shared with the at least one other user equipment. Compensating for the effect of the cyclic shift may comprise aligning at least one window in a delay domain. The cyclic shift may be a space domain and frequency domain shift.

An example apparatus includes at least one processor; and at least one non-transitory memory including computer program code; wherein the at least one memory and the computer program code are configured to, with the at least one processor, cause the apparatus at least to: determine that at least two user equipments are to share the same channel state information reference signal port; determine cyclic shifts to be used for each of the at least two user equipments; wherein the cyclic shift for at least one of the user equipments is smaller than a delay spread of a channel used for transmission of the channel state information reference signal; and transmit the channel state information reference signal to the at least two user equipments from the same channel state information reference signal port using the determined cyclic shifts.

An example apparatus includes at least one processor; and at least one non-transitory memory including computer program code; wherein the at least one memory and the computer program code are configured to, with the at least one processor, cause the apparatus at least to: receive a channel state information reference signal associated with a cyclic shift via a user equipment; wherein the cyclic shift is smaller than a delay spread of a channel used for receiving the channel state information reference signal; and process the channel state information reference signal, wherein the processing comprises compensating for an effect of the cyclic shift related to a channel state information reference signal port shared with at least one other user equipment.

An example apparatus includes means for determining that at least two user equipments are to share the same channel state information reference signal port; means for determining cyclic shifts to be used for each of the at least two user equipments; wherein the cyclic shift for at least one of the user equipments is smaller than a delay spread of a channel used for transmission of the channel state information reference signal; and means for transmitting the channel state information reference signal to the at least two user equipments from the same channel state information reference signal port using the determined cyclic shifts.

An example apparatus includes means for receiving a channel state information reference signal associated with a cyclic shift via a user equipment; wherein the cyclic shift is smaller than a delay spread of a channel used for receiving the channel state information reference signal; and means for processing the channel state information reference signal, wherein the processing comprises compensating for an effect of the cyclic shift related to a channel state information reference signal port shared with at least one other user equipment.

An example non-transitory program storage device readable by a machine, tangibly embodying a program of instructions executable by the machine for performing operations is provided, the operations comprising: determining that at least two user equipments are to share the same channel state information reference signal port; determining cyclic shifts to be used for each of the at least two user equipments; wherein the cyclic shift for at least one of the user equipments is smaller than a delay spread of a channel used for transmission of the channel state information reference signal; and transmitting the channel state information reference signal to the at least two user equipments from the same channel state information reference signal port using the determined cyclic shifts.

An example non-transitory program storage device readable by a machine, tangibly embodying a program of instructions executable by the machine for performing operations is provided, the operations comprising: receiving a channel state information reference signal associated with a cyclic shift via a user equipment; wherein the cyclic shift is smaller than a delay spread of a channel used for receiving the channel state information reference signal; and processing the channel state information reference signal, wherein the processing comprises compensating for an effect of the cyclic shift related to a channel state information reference signal port shared with at least one other user equipment.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, this description is intended to embrace all such alternatives, modifications and variances which fall within the scope of the appended claims.

1. A method comprising:
determining that at least two user equipments are to share the same channel state information reference signal port;
determining cyclic shifts to be used for each of the at least two user equipments;
wherein the cyclic shift for at least one of the user equipments is smaller than a delay spread of a channel used for transmission of the channel state information reference signal; and
transmitting the channel state information reference signal to the at least two user equipments from the same channel state information reference signal port using the determined cyclic shifts.

2. The method of claim 1, wherein the cyclic shift is determined based on a delay value used in a frequency domain precoding pilot of the at least two user equipments.

3. The method of claim 1, wherein the cyclic shift is configured to separate a frequency resource element shared on the channel state information reference signal port shared with the at least two user equipments.

4. The method of claim 1, wherein the cyclic shift is configured to align at least one window in a delay domain.

5. The method of claim 1, wherein the cyclic shift is a space domain and frequency domain shift.

6. A method comprising:
receiving a channel state information reference signal associated with a cyclic shift via a user equipment;
wherein the cyclic shift is smaller than a delay spread of a channel used for receiving the channel state information reference signal; and
processing the channel state information reference signal, wherein the processing comprises compensating for an effect of the cyclic shift related to a channel state information reference signal port shared with at least one other user equipment.

7. The method of claim 6, wherein the receiving comprises receiving the channel state information reference signal as an orthogonal frequency division multiplexing symbol.

8. The method of claim 6, wherein compensating for the effect of the cyclic shift comprises separating a frequency resource element shared on the channel state information reference signal port shared with the at least one other user equipment.

9. The method of claim 6, wherein compensating for the effect of the cyclic shift comprises aligning at least one window in a delay domain.

10. The method of claim 6, wherein the cyclic shift is a space domain and frequency domain shift.

11. An apparatus comprising:
at least one processor; and
at least one memory including computer program code;
wherein the at least one memory and the computer program code are configured to, with the at least one processor, cause the apparatus at least to:
determine that at least two user equipments are to share the same channel state information reference signal port;
determine cyclic shifts to be used for each of the at least two user equipments;
wherein the cyclic shift for at least one of the user equipments is smaller than a delay spread of a channel used for transmission of the channel state information reference signal; and
transmit the channel state information reference signal to the at least two user equipments from the same channel state information reference signal port using the determined cyclic shifts.

12. An apparatus comprising:
at least one processor; and
at least one memory including computer program code;
wherein the at least one memory and the computer program code are configured to, with the at least one processor, cause the apparatus at least to:
receive a channel state information reference signal associated with a cyclic shift via a user equipment;
wherein the cyclic shift is smaller than a delay spread of a channel used for receiving the channel state information reference signal; and
process the channel state information reference signal, wherein the processing comprises compensating for an effect of the cyclic shift related to a channel state information reference signal port shared with at least one other user equipment.

13. (canceled)

14. (canceled)

15. A non-transitory computer readable medium, encoded with instructions executable by hardware which, when executed by the hardware, causes the hardware to perform the method of claim 1.

16. A non-transitory computer readable medium, encoded with instructions executable by hardware which, when executed by the hardware, causes the hardware to perform the method of claim 6.

17. The apparatus of claim 11, wherein the cyclic shift is determined based on a delay value used in a frequency domain precoding pilot of the at least two user equipments.

18. The apparatus of claim 11, wherein the cyclic shift is configured to separate a frequency resource element shared on the channel state information reference signal port shared with the at least two user equipments.

19. The apparatus of claim 11, wherein the cyclic shift is configured to align at least one window in a delay domain.

20. The apparatus of claim 12, wherein the receiving comprises receiving the channel state information reference signal as an orthogonal frequency division multiplexing symbol.

21. The apparatus of claim 12, wherein compensating for the effect of the cyclic shift comprises separating a frequency resource element shared on the channel state information reference signal port shared with the at least one other user equipment.

22. The apparatus of claim 12, wherein compensating for the effect of the cyclic shift comprises aligning at least one window in a delay domain.
